(19) United States
(12) Patent Application Publication
(10) Pub. No.: US 2012/0008852 A1
(43) Pub. Date: Jan. 12, 2012

(54) SYSTEM AND METHOD OF ENHANCING DEPTH OF A 3D IMAGE

(75) Inventors: Sheng-Chun NIU, Tainan (TW); Ling-Hsiu HUANG, Tainan (TW)

(73) Assignee: HIMAX MEDIA SOLUTIONS, INC., Tainan (TW)

(21) Appl. No.: 12/831,853

(22) Filed: Jul. 7, 2010

(51) Int. Cl. G06T 7/00; G06K 9/00

(52) U.S. Cl. 382/154; 382/170

(57) ABSTRACT

A system and method of enhancing depth of a three-dimensional (3D) image are disclosed. A depth generator generates at least one depth map associated with an image. A depth enhancer enhances the depth map by stretching a depth histogram associated with the depth map, wherein the depth histogram is a distribution of depth levels of pixels of the image.

### BACKGROUND OF THE INVENTION

1. Field of the Invention

The present invention generally relates to digital image processing, and more particularly to a system and method of enhancing depth of a three-dimensional (3D) image.

2. Description of Related Art

When three-dimensional (3D) objects are mapped onto a two-dimensional (2D) image plane by prospective projection, such as an image taken by a still camera or a video camera, a lot of information, particularly 3D depth information, disappears. A 3D imaging system, however, can convey 3D information to a viewer by recording 3D visual information or by re-creating the illusion of depth. Although the 3D imaging technique has been known for over a century, the 3D display becomes more practical and popular owing to availability of high-resolution and low-price displays such as liquid crystal displays (LCDs).

FIG. 1A shows a block diagram of a conventional 3D imaging system that creates depth information by a depth generator 10 according to a 2D image input. The depth information is then processed by depth-image-based rendering (DIBR) 12 to generate a left (L) image 14A and a right (R) image 14B, which are then displayed and viewed by the viewer. FIG. 1B shows a block diagram of another conventional 3D imaging system that records the left image 18A and the right image 18B, which may be encoded into side-by-side, top-bottom (over-under or above-below), line-by-line (line interlace) or checkerboard etc (shown in FIG. 1D), by a 3D recorder 16 (such as blue-ray DVD disc) or TV broadcast signal. FIG. 1C shows a block diagram of another conventional 3D imaging system that records a depth map 20 and one of the left and right image 18A and 18B (defined as 2D+depth type) by a 3D recorder 16 or TV broadcast signal. The DIBR 12 then generates a corresponding R image 18B′ (or L image 18A′) for being displayed and viewed by viewer based on the depth map 20 and the L image 18A.

Conventional 3D imaging systems have some disadvantages such as limited depth range. Accordingly, the viewer oftentimes cannot distinguish objects that are supposed to possess distinct depth levels respectively.

For the reason that conventional 3D imaging systems could not effectively display 3D image or video, a need has arisen to propose a novel 3D imaging system and method with improved depth characteristics.

### SUMMARY OF THE INVENTION

In view of the foregoing, it is an object of the embodiment of the present invention to provide a system and method of enhancing depth of a three-dimensional (3D) image to increase quality of a 3D image or video such that a viewer can perceive more depth levels.

According to one embodiment, a depth generator generates at least one depth map associated with an image. A depth enhancer enhances the depth map by stretching a depth histogram associated with the depth map, wherein the depth histogram is a distribution of depth levels of pixels of the image.

According to another embodiment, a depth map associated with an image is received, and the depth map is segmented into a number of divided depth maps. Subsequently, a number of local depth histograms are generated according to the divided depth maps respectively. Finally, the divided depth maps are individually enhanced by modifying depth characteristics of the image.

### BRIEF DESCRIPTION OF THE DRAWINGS

FIG. 1A shows a block diagram of a conventional three-dimensional (3D) imaging system;

FIG. 1B shows a block diagram of another conventional 3D imaging system;

FIG. 1C shows a block diagram of another conventional 3D imaging system;

FIG. 1D shows a number of 3D formats for a 3D recorder or broadcast signal;

FIG. 2 shows a block diagram illustrating a system of enhancing depth of a 3D image according to one embodiment of the present invention;

FIG. 3 shows a flow diagram illustrating a method of enhancing depth of a 3D image according to one embodiment of the present invention;

FIG. 4A shows an exemplary depth histogram according to an original depth map;

FIG. 4B shows an enhanced depth histogram after performing the depth histogram stretching;

FIG. 5 shows an S-curve transformation on the depth levels of a depth histogram;

FIG. 6 shows a flow diagram illustrating a method of enhancing depth of a 3D image according to another embodiment of the present invention; and

FIG. 7 shows exemplary local depth histograms that are generated according to corresponding divided depth maps.

### DETAILED DESCRIPTION OF THE INVENTION

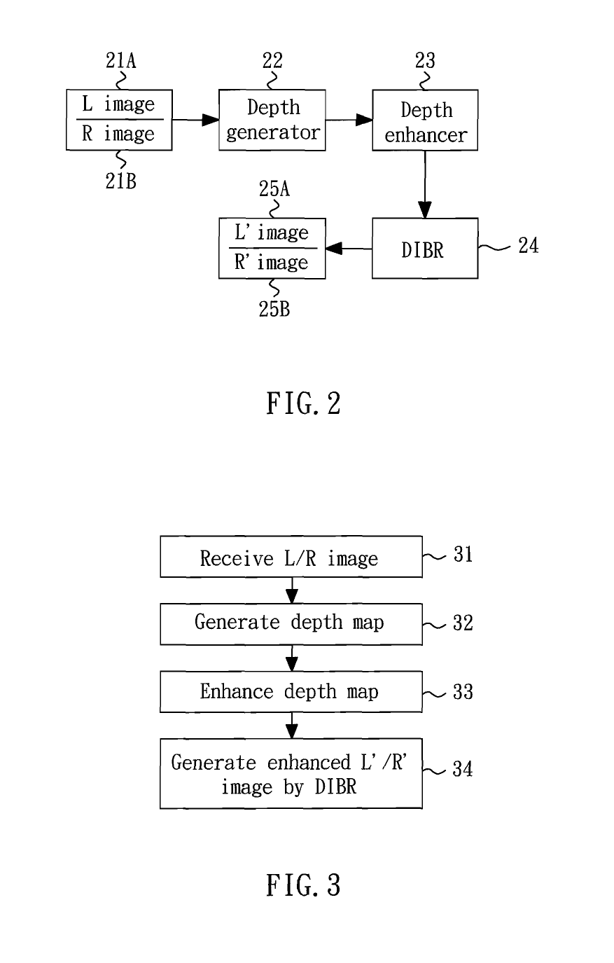

FIG. 2 shows a block diagram illustrating a system of enhancing depth of a three-dimensional (3D) image according to one embodiment of the present invention. FIG. 3 shows a flow diagram illustrating a method of enhancing depth of a 3D image according to one embodiment of the present invention. The 3D image is also called a stereoscopic image.

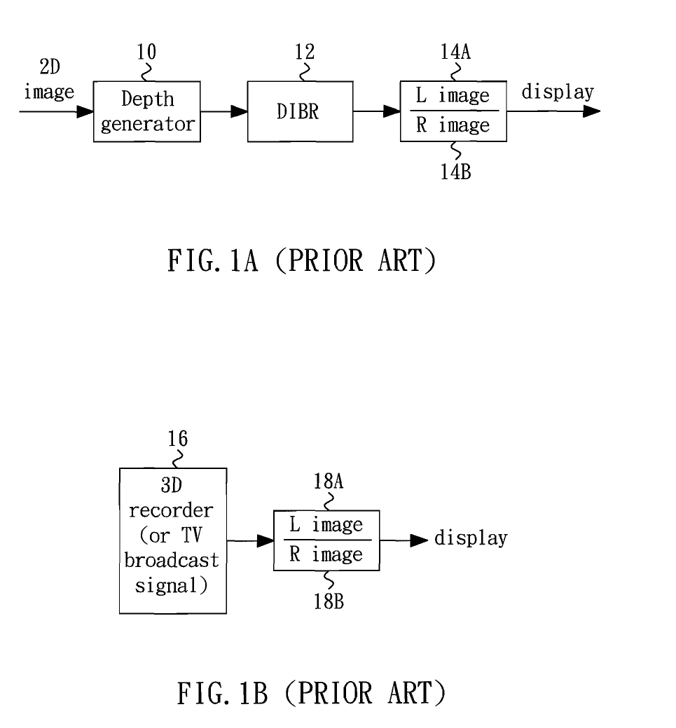

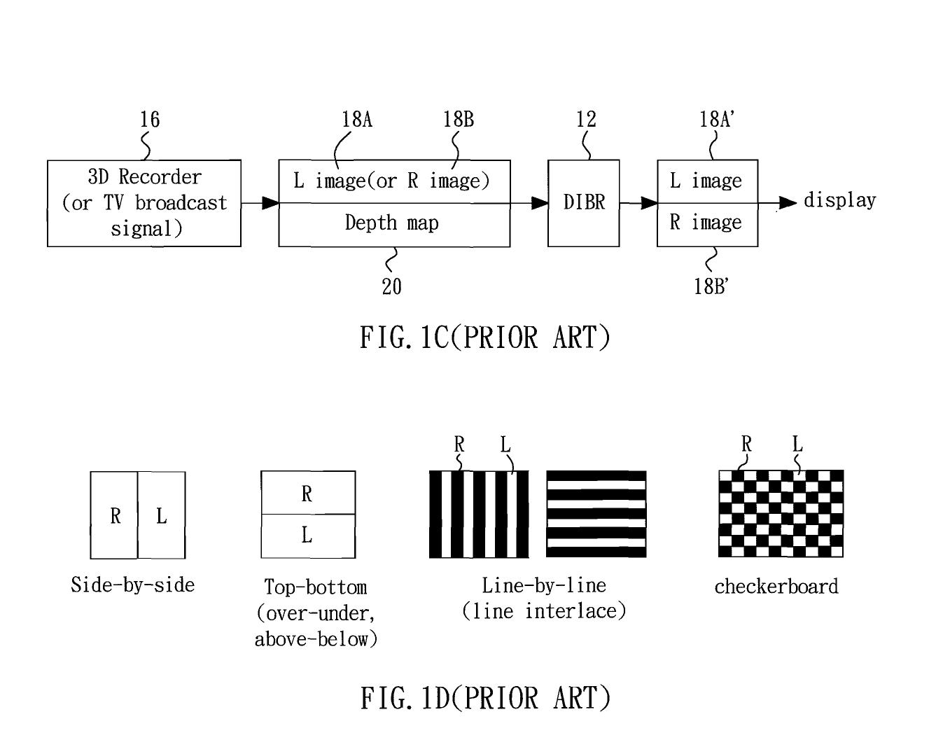

In step 31, a left (L) image 21A and a right (R) image 21B displayable in a 3D imaging system are received, followed by generating at least one depth map, in step 32, by a depth generator 22. For example, the depth generator 22 may generate a left depth map and a right depth map that correspond to the original left image and the right image respectively. In another example, the depth generator 22 may generate a single depth map. In the depth map, each pixel or block has its corresponding depth value. For example, an object near a viewer has a greater depth value than an object far from the viewer. As a result, in a depth-map image, the object near the viewer is brighter than the object far from the viewer. In another embodiment, the depth map may be provided, for example, by a depth generator (e.g., 10 in FIG. 1A) or a 3D recorder (e.g., 16 in FIG. 1C) in a 3D imaging system.

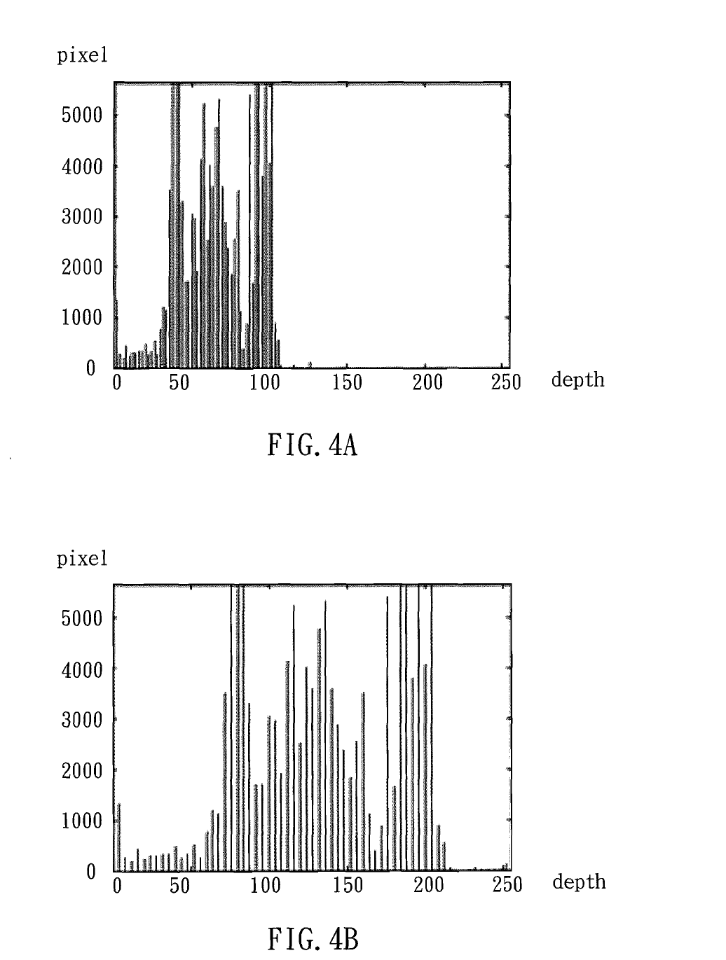

Subsequently, in step 33, the depth map or maps from the depth generator 22 are enhanced by a depth enhancer 23 to modify or improve depth characteristics of the image(s). In the embodiment, depth histogram stretching is performed on the depth map from the depth generator 22. The depth histogram is a distribution (usually depicted as a graph) of the depth levels of pixels, in which each depth level has its counted number of pixels. If the histogram is depicted as a graph, the horizontal axis represents the depth levels and the vertical axis represents the corresponding number of pixels. FIG. 4A shows an exemplary depth histogram according to an original depth map, and FIG. 4B shows an enhanced depth histogram after performing the depth histogram stretching. It is observed that the image corresponding to the original depth map primarily has pixels with depth levels less than 100, and the enhanced image corresponding to the enhanced depth map has pixels with depth levels substantially stretching over the entire depth levels.

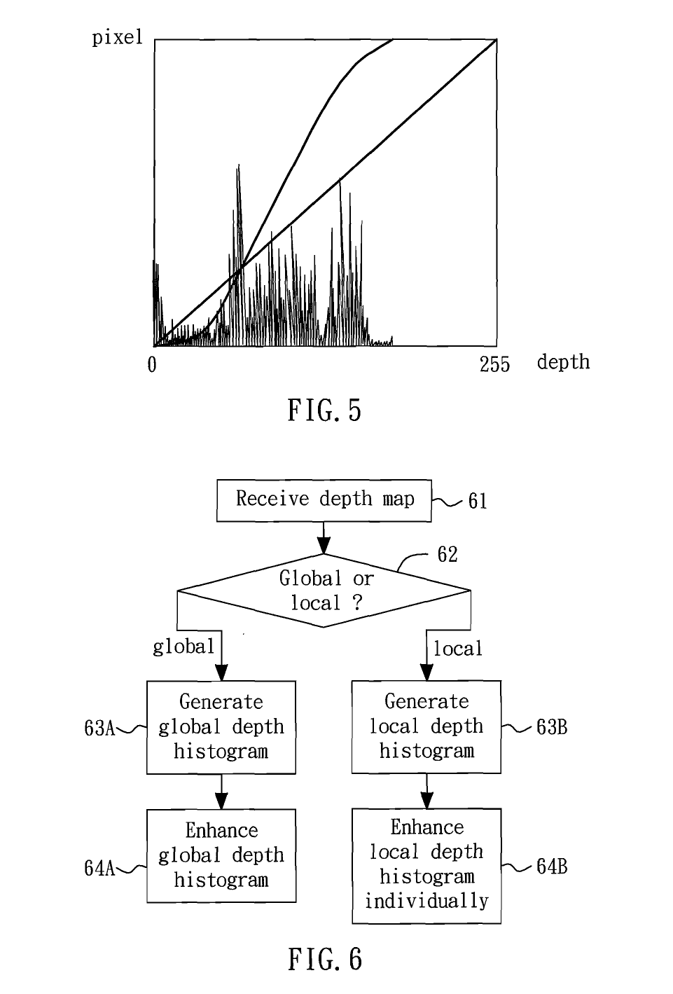

In a specific embodiment, the depth histogram stretching may be performed by applying a gain on each depth level. In another specific embodiment, the depth histogram stretching may be performed by applying a transformation (or mapping) characterized by a curve (e.g., a gamma curve) on the depth levels of a depth histogram. FIG. 5 shows an S-curve transformation on the depth levels of a depth histogram. As shown in the figure, the greatest slope of the S curve passes the depth level with greatest number of pixels. Generally speaking, the depth histogram stretching may be performed by equalizing each depth level of the depth histogram by addition, subtraction, multiplication or division of a value to each depth level.

Afterwards, in step 34, the enhanced depth map (or maps) from the depth enhancer 23 are fed to a depth-image-based rendering (DIBR) unit 24, which generates (or synthesizes) an enhanced left (L′) image 25A and an enhanced right (R′) image 25B according to the enhanced depth map(s) and the original left (L) image and the right (R) image. The resulting enhanced left image and enhanced right image may then be displayed by a 3D imaging system. The DIBR unit 24 may be implemented by a suitable conventional technique, for example, disclosed in a disclosure entitled “A 3D-TV Approach Using Depth-Image-Based Rendering (DIBR),” by Christoph Fehn, the disclosure of which is hereby incorporated by reference.

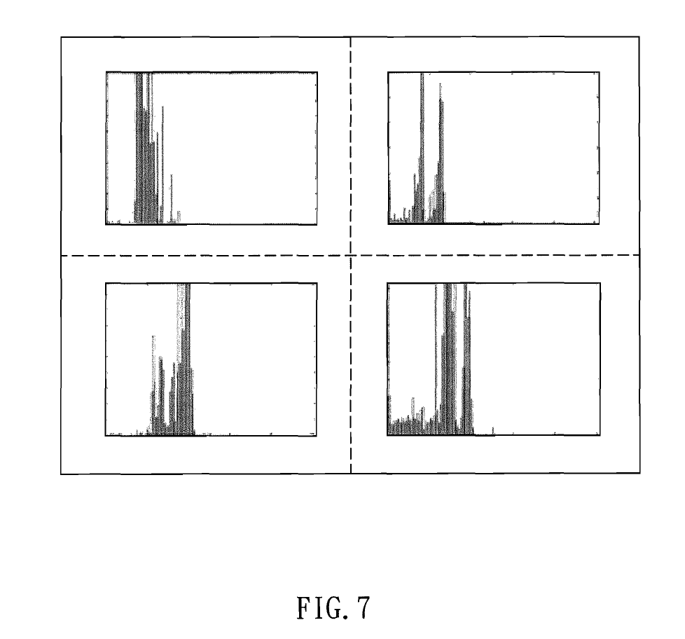

FIG. 6 shows a flow diagram illustrating a method of enhancing depth of a 3D image according to another embodiment of the present invention. In step 61, a depth map is received, for example, from the depth generator 22 (FIG. 2). Subsequently, in step 62, it is determined whether the following depth enhancement is performed globally or locally.

If the depth enhancement is to be performed globally, a global depth histogram is then generated, in step 63A, according to the entire depth map. Subsequently, in step 64A, the global depth histogram is enhanced, for example, by S-curve transformation (or mapping) on the depth levels of the global depth histogram, as exemplified in FIG. 5.

If the depth enhancement is to be performed locally, a number of local depth histograms are then respectively generated, in step 63B, according to divided depth maps of the received depth map. FIG. 7 shows exemplary local depth histograms that are generated according to corresponding divided depth maps. In this example, the entire depth map is segmented into 2×2 or 4 divided depth maps. Subsequently, in step 64B, the local depth histograms are individually enhanced, for example, by S-curve transformation (or mapping) on the depth levels of the local depth histograms. Each local depth histogram may be subjected to different transformation, and some of the local depth histograms may even not be subjected to transformation.

Although specific embodiments have been illustrated and described, it will be appreciated by those skilled in the art that various modifications may be made without departing from the scope of the present invention, which is intended to be limited solely by the appended claims.

What is claimed is:

1. A system of enhancing depth of a three-dimensional (3D) image, comprising:
a depth generator configured to generate at least one depth map associated with an image; and
a depth enhancer configured to enhance the depth map by stretching a depth histogram associated with the depth map, wherein the depth histogram is a distribution of depth levels of pixels of the image.

2. The system of claim 1, wherein a gain is applied on each said depth level of the depth histogram.

3. The system of claim 1, wherein a transformation characterized by a curve is applied on the depth levels of the depth histogram.

4. The system of claim 3, wherein the curve is a gamma curve.

5. The system of claim 1, wherein S-curve transformation is applied on the depth levels of the depth histogram.

6. The system of claim 1, wherein each said depth level of the depth histogram is equalized by addition, subtraction, multiplication or division of a value to each said depth level.

7. The system of claim 1, wherein the depth generator generates a left depth map corresponding to a left image and generates a right depth map corresponding to a right image.

8. The system of claim 1, further comprising a depth-image-based rendering (DIBR) unit configured to receive the enhanced depth map and accordingly generate an enhanced left image and an enhanced right image.

9. A method of enhancing depth of a three-dimensional (3D) image, comprising:
receiving at least one depth map associated with an image;
generating a depth histogram associated with the depth map, wherein the depth histogram is a distribution of depth levels of pixels of the image; and
enhancing the depth map by stretching the depth histogram.

10. The method of claim 9, wherein the step of stretching the depth histogram comprises:
applying a gain on each said depth level of the depth histogram.

11. The method of claim 9, wherein the step of stretching the depth histogram comprises:
applying a transformation characterized by a curve on the depth levels of the depth histogram.

12. The method of claim 11, wherein the curve is a gamma curve.

13. The method of claim 9, wherein the step of stretching the depth histogram comprises:
applying S-curve transformation on the depth levels of the depth histogram.

14. The method of claim 9, wherein the step of stretching the depth histogram comprises:
equalizing each said depth level of the depth histogram by addition, subtraction, multiplication or division of a value to each said depth level.

15. The method of claim 9, wherein said at least one depth map comprises a left depth map corresponding to a left image and a right depth map corresponding to a right image.

16. The method of claim 9, further comprising:
receiving the enhanced depth map and accordingly generating an enhanced left image and an enhanced right image.

17. A method of enhancing depth of a three-dimensional (3D) image, comprising:
receiving a depth map associated with an image;
segmenting the depth map into a plurality of divided depth maps;
generating a plurality of local depth histograms according to the divided depth maps respectively; and
individually enhancing the divided depth maps by modifying depth characteristics of the image;
wherein each said local depth histogram is a distribution of depth levels of pixels of the image associated with the corresponding divided depth map.

18. The method of claim 17, wherein the step of enhancing the divided depth maps comprises:
stretching the local depth histograms.
